(19) United States
(12) Patent Application Publication
(10) Pub. No.: US 2001/0042241 A1
(43) Pub. Date: Nov. 15, 2001

(54) Apparatus and method for executing program using just-in time-compiler system

(75) Inventor: Akira Tsuboi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/733,674

(22) Filed: Dec. 8, 2000

(30) Foreign Application Priority Data
Jan. 21, 2000 (JP) 2000-12599

(51) Int. Cl. G06F 9/45

(52) U.S. Cl. 717/5

(57) ABSTRACT

A program execution device includes: a storage unit storing for each function a machine language executable by an execution unit obtained by compiling a function described in a source program, and maintaining the stored data although a power supply voltage has dropped; a compiling unit compiling the source program into a machine language executable by the execution unit; a storage control unit storing the machine language compiled by the compiling unit; a determination unit determining whether or not a machine language obtained by compiling a function used in the source program is stored in the storage unit; and an execution control unit instructing the execution unit to directly execute either a machine language compiled by the compiling unit or a machine language stored in the storage unit depending on the determination result obtained by the determination unit.

### BACKGROUND OF THE INVENTION

1. Field of the Invention

The present invention relates to a technology of executing a program expressed in a high level programming language in a processing system, and more specifically to a technology of compiling a source program in a just-in-time-compiler system into an executable program in a machine language on a platform of a specific processing system, and executing the machine language.

2. Description of the Related Art

There have been a large number of attempts to operate the same program on the platforms of different processing systems. A programming language Java (Java is a registered trademark of Sun Microsystems Incorporated) is one of the answers. Java realizes a platform-independent system, and excels in portability among different types of platforms.

The source code of a program expressed in Java is normally processed in a syntax analysis, etc., converted into a binary file called byte code, and then distributed. A Java byte code is a general-purpose instruction code independent of a platform of a processing system, interpreted and executed in a Java executing system referred to as a Java VM (virtual machine). When various processing systems are provided with the environment corresponding to the Java VM, the same Java byte code can be executed in different processing systems.

Described below is the technology of executing the Java byte code in a processing system.

A Java interpreter sequentially interprets a Java byte code for each instruction, and allows a processing system to perform a process corresponding to the instruction. The Java interpreter has merit of a program expressed by the Java byte code, interpreted as is and processed, but has demerit of the time required to interpret an instruction, thereby slowing the process.

A method of compiling in advance the Java byte code for a native code which is a machine language directly executable by a processing system can be used as a method for improving throughput of the program expressed in the Java byte code, and a tool for the compiling process is referred to as a native compiler. The throughput of a program can be considerably enhanced by compiling the Java byte code into native code, but there is the problem that the portability among different platforms, which is the noticeable merit of Java, is lost. Furthermore, each time the Java byte code is updated by changing a program, an operator of a processing system has to instruct the system to compile the Java byte code into a native code.

A just-in-time compiler (hereinafter referred to as a ‘JIT compiler’) is suggested to maintain the merit of Java, that is, the portability among different platforms, and improve the problem of the Java interpreter in throughput.

When the Java byte code is executed, the JIT compiler allows a processing system to sequentially execute the code while compiling the code into native code in a function (method in Java) unit used in the Java byte code. At this time, a compiled native code is stored in the main memory. When a function already compiled into native code appears as the Java byte code is compiled, the function is not recompiled, but the native code stored in the main memory is directly executed by the processing system, thereby shortening the processing time required by the compiling process. Normally, a function decelerating the process of the entire program is repeatedly called in many cases. Therefore, the throughput can be improved in this method using the Java byte code.

Since the JIT compiler also optimizes an instruction expressed by the Java byte code, which is difficult in an interpreting process performed by an interpreter, the optimization improves the throughput of the system. Furthermore, the JIT compiler is free of the complicated operations necessarily performed by an operator of the native compiler on the processing system.

A JIT compiler used for executing the Java byte code is popularly used, but it also can be configured such that a program expressed in another programming language and a program (generally referred to as a ‘source program’ in this specification) expressed in an intermediate language obtained by performing a syntax analysis and an optimizing process on a program can be compiled into the native code which can be directly interpreted by a specific platform, and executed on the platform.

As described above, the problem of the JIT compiler about the throughput can be solved while maintaining the merit of Java, that is, the portability among different platforms. Furthermore, it has the merit that the load of operations to be performed by an operator is smaller than the load in the native code. However, since it is always necessary to compile native code when the execution of a source program starts, there has been the problem in the execution of a source program using the JIT compiler that there occurs a time lag until the process described in the source program is actually started.

### SUMMARY OF THE INVENTION

The present invention aims at improving the performance when the execution of a source program is started using the JIT compiler.

One of the embodiments of the present invention is based on an apparatus for compiling a source program into a machine language directly executable on a platform of a specific processing system, and executing the machine language using a just-in-time-compiler system. In the apparatus, the machine language obtained by compiling the source program is stored in a storage unit for maintain the stored data for each function expressed in the source program although the supply voltage has dropped. Then, it is determined whether or not the machine language obtained by compiling the function described in the source program is stored in the storage unit. Based on the determination result, either the machine language obtained by compiling the source program or the machine language stored in the storage unit is directly executed on the platform of a specific processing system.

With the configuration, when the same source program is re-executed after turning off the power supply, a source program can be executed without a time lag caused by a program compiling process when the execution is started.

Another embodiment of the present invention is based on an apparatus for compiling a source program into a machine language directly executable on a platform of a specific processing system, and executing the machine language using a just-in-time-compiler system. In the apparatus, the machine language obtained by compiling the source program is stored for each function expressed in the source program corresponding to the date and time of the update of the source program before compiling into the machine language. Then, it is determined whether or not the date and time of the update of the source program matches the update date and time corresponding to the stored machine language. Based on the determination result, either the machine language obtained by compiling the source program or the machine language stored in the storage unit is directly executed on the platform of a specific processing system.

With the configuration, although a source program is amended, the source program can be correctly executed based on the amendment without a time lag caused by a program compiling process.

As described above, the performance at the start of the execution of the source program using the JIT compiler can be enhanced with any of the above mentioned configurations.

### BRIEF DESCRIPTION OF THE DRAWINGS

The present invention will be more apparent from the following detailed description when the accompanying drawings are referenced.

FIG. 1 shows the configuration of the principle of the present invention;

FIG. 2 shows the entire configuration of the program execution apparatus embodying the present invention;

FIG. 3 shows the entire flow of the compiling and executing process by the program execution device embodying the present invention;

FIG. 4 is a table of an example of a management note;

FIG. 5 is a flowchart of the contents of the process in the first example of the JIT compiling process;

FIG. 6 shows the data stored in the hard disk device in the second example of the program execution device embodying the present invention;

FIG. 7 is a table of an example of a management note in the second example of the program execution device;

FIG. 8 is a flowchart of the contents of the process in the second example of the JIT compiling process;

FIG. 9 shows the data stored in the RAM in the third example of the program execution device embodying the present invention;

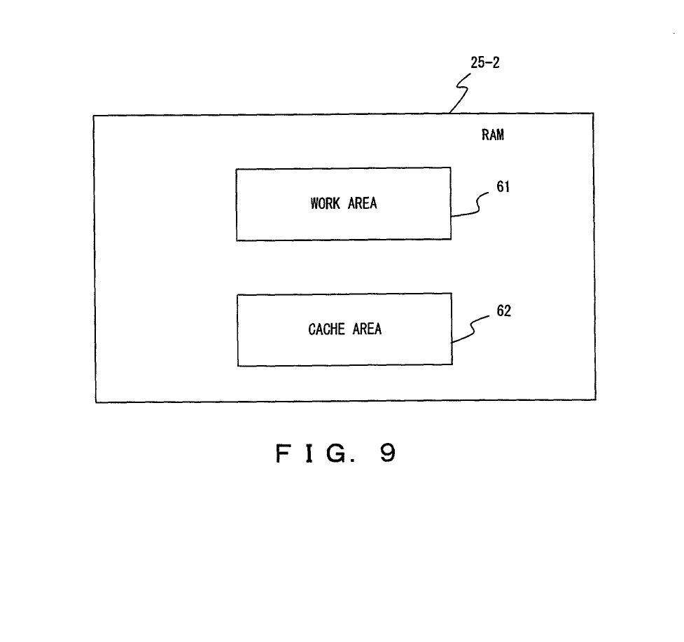

FIG. 10 is a flowchart of the contents of the control process of the entire device in the third example of the program execution device embodying the present invention;

FIG. 11 is a flowchart of the contents of the JIT compiling process shown in FIG. 10; and

FIG. 12 shows an example of a storage medium capable of reading a control program using a computer.

### DESCRIPTION OF THE PREFERRED EMBODIMENTS

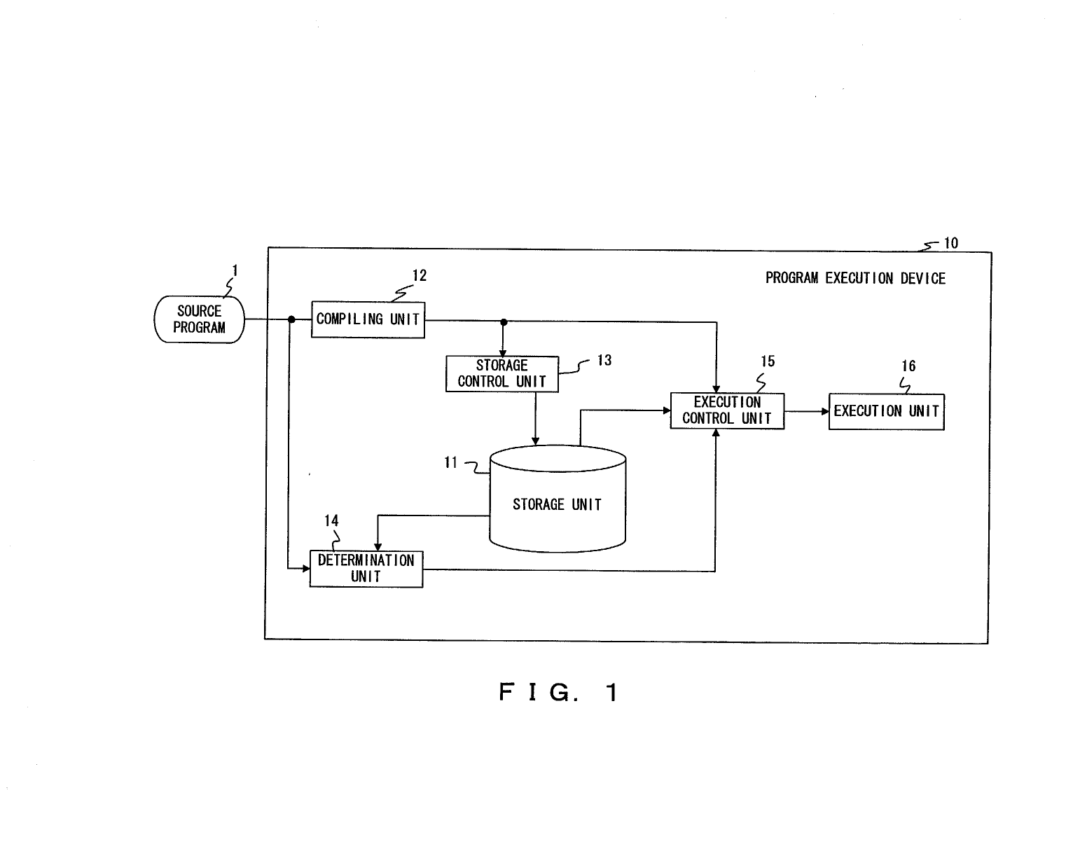

FIG. 1 shows the configuration of the principle of the present invention, and shows the configurations according to the first and second aspects of the present invention. FIG. 1 is described below in detail. A program execution device 10 according to the present invention comprises an execution unit 16 for executing a machine language based on the device for compiling a source program 1 into a machine language directly executable by the execution unit 16 and executing it.

In the apparatus according to the first aspect of the present invention, the program execution device 10 comprises: a storage unit 11 for storing a machine language executable by the execution unit 16 obtained by compiling a function described in a source program for each function, and maintaining the stored data although the power supply voltage has dropped; a compiling unit 12 for compiling the source program 1 into a machine language executable by the execution unit 16; a storage control unit 13 for storing the machine language compiled by the compiling unit 12; a determination unit 14 for determining whether or not the machine language obtained by compiling the function used in the source program 1 is stored in the storage unit 11; and an execution control unit 15 for instructing the execution unit 16 to directly execute either a machine language compiled by the compiling unit 12 or a machine language stored in the storage unit 11 depending on a determination result obtained by the determination unit 14.

With the configuration, the storage unit 11 can be, for example, a hard disk device, flash EEPROM (flash type electrically erasable and programmable read only memory), etc.

With the above mentioned configuration, the storage unit 11 stores a machine language obtained by compiling a function described in the source program 1. If the determination unit 14 determines that a machine language obtained by compiling a function used in the source program 1 is stored in the storage unit 11, then the execution control unit 15 controls the execution unit 16 to directly execute the machine language of the function stored in the storage unit 11 without waiting for the compilation of the function by the compiling unit 12. Therefore, the program execution device 10 performs the operation corresponding to the JIT compiler. As a result, with the above mentioned configuration, there can be the merit of the above mentioned JIT compiler.

Furthermore, the storage unit 11 with the above mentioned configuration maintains the stored data although the power supply voltage has dropped. Therefore, if, for example, the operator turns off the power source of the program execution device 10 after completing the work for the day, and resumes his or her work the next day, and if the same source program 1 is executed at least once by the previous day, then the machine language stored in the storage unit 11 and obtained by compiling the function described in the source program 1 can be used from the initial execution of the day. Therefore, the program execution device 10 can execute the source program 1 without a time lag caused in the compiling process when the execution is started.

With the above mentioned configuration, the storage unit 11 can be configured such that a machine language obtained by compiling a function which can be used in the source program 1 can be stored in advance in the storage unit 11. With this configuration, there is a possibility that a machine language obtained by compiling a function described in the source program 1 when the source program 1 is first executed by the program execution device 10 has already been stored. In this case, the machine language obtained by compiling the function described in the source program 1 can be obtained from the storage unit 11. Therefore, the time lag caused in the program compiling process when the execution is started can be successfully shortened.

In addition, with the block diagram configuration, the apparatus according to the present invention can further comprise a semiconductor memory for copying and storing the data stored in the storage unit 11, and the execution control unit 15 can instruct the execution unit 16 to execute the machine language which is a copy, stored in the semiconductor memory, of the data stored in the storage unit 11 instead of instructing the execution unit 16 to execute the machine language stored in the storage unit 11. For example, when a hard disk device is used as the storage unit 11, the machine language can be retrieved and read at a higher speed by reading the machine language from the semiconductor memory storing the copied contents which are the same as those in the hard disk device than reading the machine language from the hard disk device. Therefore, the compiling and executing time required by the program execution device 10 for the source program 1 can be furthermore shortened.

In the apparatus according to the second aspect of the present invention, the program execution device 10 comprises: a storage unit 11 for storing a machine language executable by the execution unit 16 obtained by compiling a function described in a source program for each function, and maintaining the stored data even after the source program 1 has been executed; a compiling unit 12 for compiling the source program 1 into a machine language executable by the execution unit 16; the storage control unit 13 for instructing the storage unit 11 to store the machine language compiled by the compiling unit 12 corresponding to the update date and time of the source program 1 compiled by the compiling unit 12; the determination unit 14 for determining whether or not the update date and time of the source program 1 matches the update date and time corresponding to the machine language stored in the storage unit 11; and the execution control unit 15 for instructing the execution unit 16 to directly execute either the machine language compiled by the compiling unit 12 or the machine language stored in the storage unit 11 depending on the determination result obtained by the determination unit 14.

In the above mentioned configuration, the apparatus further comprises a read unit for reading a program file storing the source program 1, the storage control unit 13 assumes that the update date and time of the program file indicated in the program file storing the source program 1 is the update date and time of the source program 1 corresponding to the machine language, the storage unit 11 stores the machine language, and the determination unit 14 determines whether or not the update date and time of the program file indicated in the program file matches the update date and time stored in the storage unit 11 corresponding to the machine language.

The above mentioned configuration, as in the above mentioned first aspect of the present invention, has the merit of the JIT compiler.

Furthermore, with the above mentioned configuration, since the stored data are maintained even after the source program 1 has been executed, the execution control unit 15 can execute the source program 1 without a time lag caused in the program compiling process when the execution is started by instructing the execution unit 16 to directly execute the machine language of the function stored in the storage unit 11 without waiting for the compilation of the source program 1 by the compiling unit 12 when the same source program 1 is re-executed. At this time, however, the source program 1 executed later may not match that executed previously by an amendment after the update of the source program, etc. Therefore, the storage control unit 13 instructs the storage unit 11 to store the machine language compiled by the compiling unit 12 corresponding to the update date and time of the source program 1 compiled by the compiling unit 12, the determination unit 14 determines whether or not the update date and time of the source program 1 matches the update date and time stored in the storage unit 11 corresponding to the machine language. If they do not match each other as a result of the determination, then the execution control unit 15 instructs the execution unit 16 to execute the machine language newly compiled by the compiling unit 12 although the machine language obtained by compiling the function used in the source program 1 is stored in the storage unit 11. Thus, even if the source program 1 has been amended, the source program 1 can be correctly executed based on the amendment.

With the above mentioned configuration, the storage unit 11 is not limited to a unit for maintaining the stored data even after the power supply voltage has dropped such as a hard disk device, flash EEPROM, etc., but can be a readable/writable storage medium.

In the apparatus according to the above mentioned first or second aspect of the present invention, the source program 1 can be expressed by the Java byte code. In this case, the function described in the source program 1 corresponds to the method by Java.

The embodiments of the embodiment are described below by referring to the attached drawings. An example of embodying the present invention in a program execution apparatus for compiling and executing the Java byte code is described below.

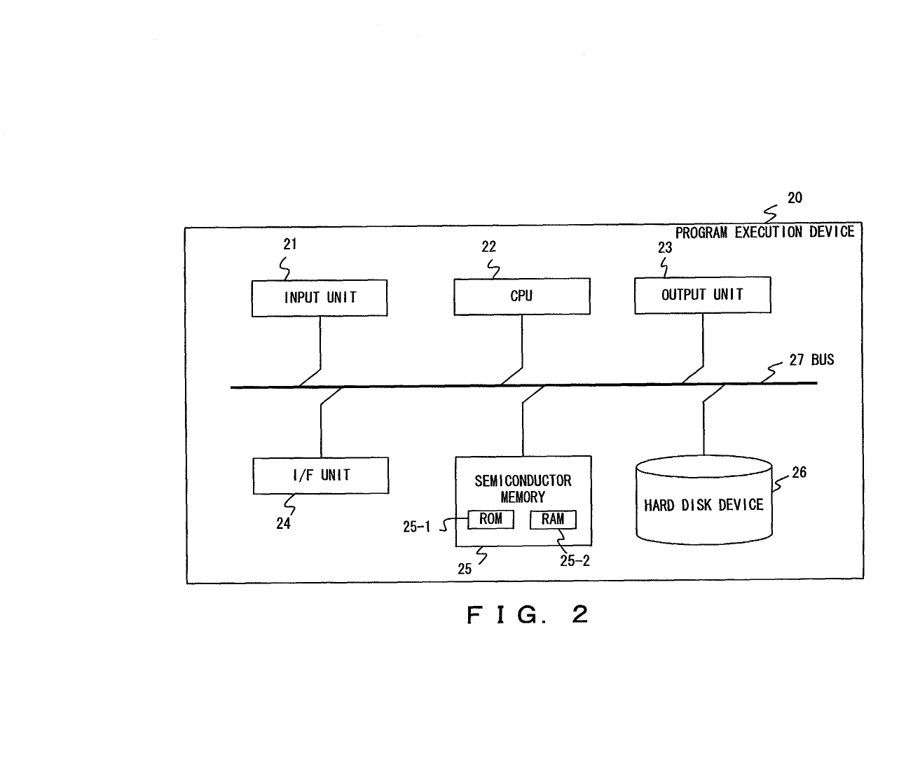

FIG. 2 shows the entire configuration of the program execution apparatus embodying the present invention. As shown in FIG. 2, a program execution device 20 (hereinafter referred to as the present device) comprises an input unit 21, a CPU 22, an output unit 23, an I/F unit 24, semiconductor memory 25, and a hard disk device 26. These units are interconnected through a bus 27.

The input unit 21 comprises a pointing device such as a keyboard device, a mouse, etc., receives various instructions from an operator of the present device, and can also comprise a data read device for reading data from a storage medium such as a floppy disk, a magneto-optical disk, a magnetic tape, etc.

The CPU 22 is the central processing unit for controlling the operation of the entire operation of the present device 20 according to the control program stored in the semiconductor memory 25, and directly executes a machine language.

The output unit 23 comprises a display device, a printer, etc., to present the result, etc. of the process performed by the present device 20 to the operator.

The I/F unit 24 controls the interfacing process for connecting the present device 20 to other devices and networks.

The semiconductor memory 25 stores in advance a control program for directing the CPU 22 to perform the control process on the entire device 20, copies and stores the data stored in the hard disk device 26, or is used as a work area for a process performed by the CPU 22, and has ROM (read-only memory) 25-1 and RAM (random-access memory) 25-2.

The hard disk device 26 is a data storage device in which the stored data can be maintained even if the power supply voltage to be provided for the present device 20 has dropped.

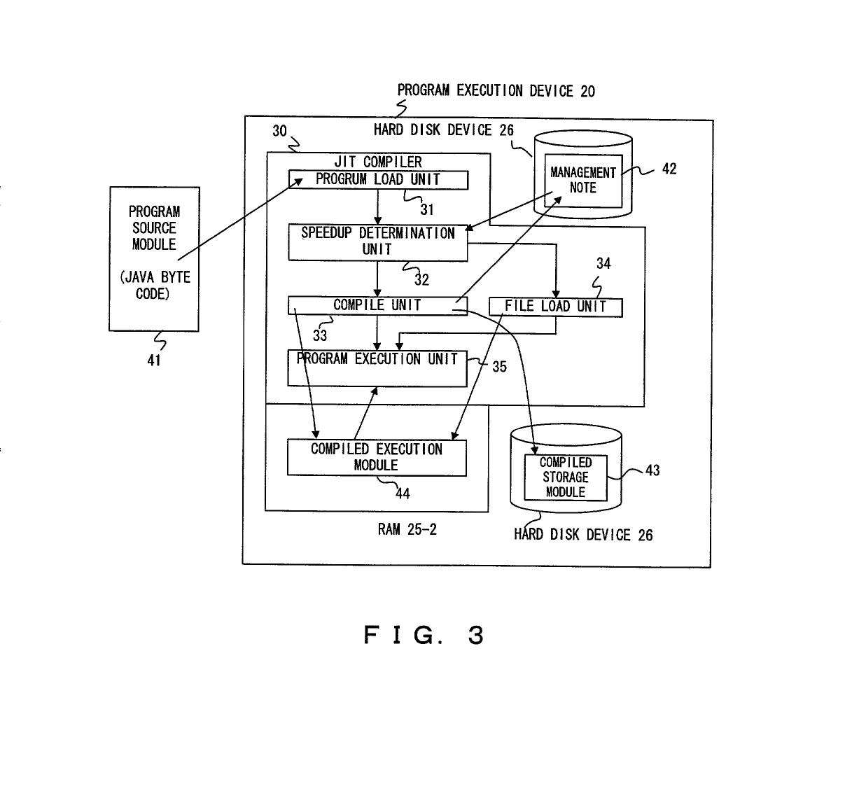

Described below is the process flow shown in FIG. 3. FIG. 3 shows the flow of the entire compiling and executing process performed by the present device 20.

A program source module 41 is a software module for directing the present device 20 to perform a compiling and executing process, and is expressed by the Java byte code according to the present embodiment. The program source module 41 can be fetched by the present device 20 by a data read device of the input unit 21 reading what is provided as a program file stored in the above mentioned storage medium, or by the I/F unit 24 receiving what is transmitted as a program file from other devices and networks.

The program source module 41 input to the present device 20 is compiled and executed by the JIT compiler 30. A JIT compiler 30 can be realized by the CPU 22 executing the control program for the entire device 20.

The contents of the processes performed by the JIT compiler 30 are divided into the functions of a program load unit 31, a speedup determination unit 32, a compile unit 33, a file load unit 34, and a program execution unit 35.

The program load unit 31 retrieves the program source module 41 from the program file fetched by the present device 20, and stores it in an area (work area) used by the CPU 22 as a work memory in the RAM 25-2.

The speedup determination unit 32 analyzes the syntax of the program source module 41, and determines whether or not the native code (a compiled storage module 43) corresponding to the compilation of the definition of the method described in the module is stored in the hard disk device 26 by referring to a management note 42. According to the present embodiment, the management note 42 is stored in the hard disk device 26.

When the speedup determination unit 32 determines that the above mentioned compiled storage module 43 corresponding to the compilation of the definition of the method is not stored in the hard disk device 26, the compile unit 33 compiles the definition of the method, stores the obtained native code directly executed by the CPU 22 as a compiled execution module 44 in the above mentioned work area in the RAM 25-2, and also as the compiled storage module 43 in the hard disk device 26. Furthermore, the compile unit 33 updates the management information about the compiled storage module 43 stored in the management note 42.

When the speedup determination unit 32 determines that compiled storage module 43 corresponding to the above mentioned compilation of the definition of the method is stored in the hard disk device 26, the file load unit 34 loads (reads) the compiled storage module 43 from the hard disk device 26, and stores it as the compiled execution module 44 in the work area of the RAM 25-2.

The program execution unit 35 directly executes through the CPU 22 the compiled execution module 44 stored in the work area of the RAM 25-2 by the compile unit 33 or the file load unit 34.

The JIT compiler 30 executes the program source module 41 by repeatedly performing the processes indicated by the function blocks of the speedup determination unit 32, the compile unit 33, the file load unit 34, and the program execution unit 35.

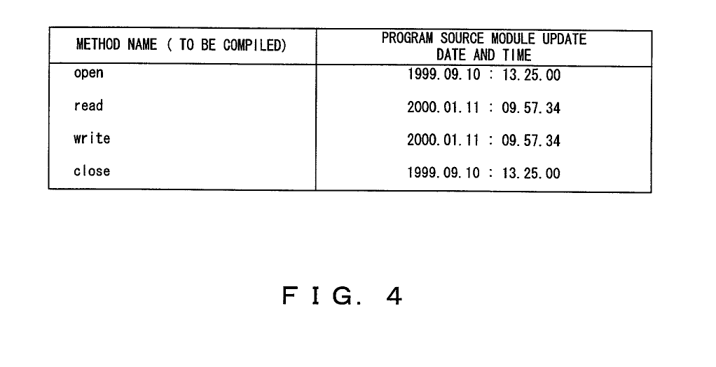

Described below is the management note 42. FIG. 4 is a table showing an example of the management note 42. The management note 42 stores the management information about the compiled storage module 43 stored in the hard disk device 26.

The left column on the table shown in FIG. 4 contains the names of the methods, which are to be compiled into the compiled storage modules 43, corresponding to the compiled storage modules 43 stored in the hard disk device 26. Then, the right column on the table shown in FIG. 4 contains the update dates and times of the program source module 41 describing the method definitions corresponding to the method names in the left columns. The update date and time is expressed as the management information about the program file storing the program source module 41.

The speedup determination unit 32 analyzes the program source module 41 stored in the work area of the RAM 25-2 by the program load unit 31. Then, it determines whether or not the update date and time of the program source module 41 matches the update date and time corresponding to the method name of the method definition stored in the management note 42. If the determination result is true, it is determined that the compiled storage module 43 corresponding to the compilation of the definition of the method is stored in the hard disk device 26.

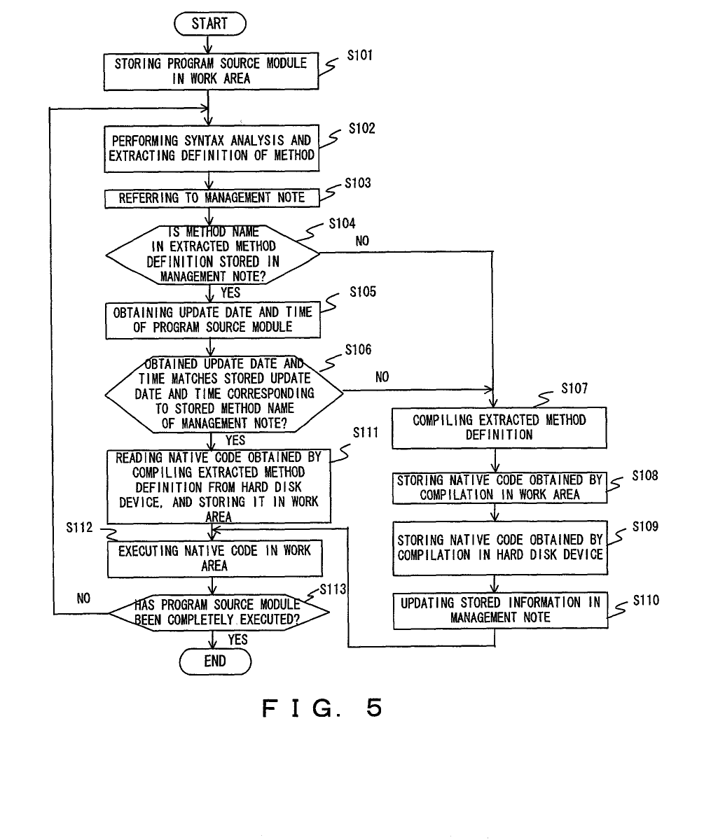

Described below is the flowchart shown in FIG. 5. FIG. 5 is a flowchart of the contents of the process as the first example of the JIT compiling process for compiling and executing the program source module 41 related to the present invention in the control processes performed by the CPU 22 executing the control program for the entire device 20 stored in the ROM 25-1. The JIT compiling process performed by the CPU 22 as shown in FIG. 5 is described below.

The CPU 22 retrieves the program source module 41 from the program file fetched into the present device 20, and stores it in the work area of the RAM 25-2 (S101). This process corresponds to the function of the program load unit 31 shown in FIG. 3.

Then, the CPU 22 analyzes the syntax of the program source module 41 stored in the work area of the RAM 25-2, and extracts a definition of a method described therein (S102). The CPU 22 refers to the management note 42 (S103), and determines whether or not the method name of the extracted method definition is contained in the management note 42 (S104). If the determination result is YES, then control is passed to S105. If it is NO, control is passed to S107.

If the method name of the extracted method definition is contained in the management note 42, the CPU 22 checks the management information about the program file storing the program source module 41, and obtains the update date and time of the program source module 41 (S105). Then, it determines whether or not the update date and time of the program source module 41 matches the update date and time stored in the management note 42 corresponding to the storage of the method name of the extracted method definition (S106). If the determination result is YES control is passed to S111. If it is NO, control is passed to S107.

The process in S102 through S106 corresponds to the function of the speedup determination unit 32 shown in FIG. 3.

If the result of the determining process in S104 or S106 is NO, the CPU 22 compiles the method definition extracted in the process in S102 (S107), stores the resultant native code directly executed by the CPU 22 as the compiled execution module 44 in the work area of the RAM 25-2 (S108), and furthermore stores the native code in the hard disk device 26 as the compiled storage module 43 (S109). The storage of the native code is maintained in the hard disk device 26 even after the program source module 41 has been compiled and executed, and the CPU 22 has temporarily terminated the JIT compiling process shown in FIG. 5.

Then, the CPU 22 updates the management note 42, stores the method name of the method definition compiled in S107, corresponding to the update date and time indicated in the management information about the program file storing the program source module 41 in which the method definition is described (S110), and then passes control to S112.

The process performed in S107 through S110 corresponds to the function of the compile unit 33 shown in FIG. 3.

If the result of the above mentioned determining process in S106 is YES, then the CPU 22 reads from the hard disk device 26 the native code obtained by compiling the method definition extracted in the process in S102, and stores the read native code in the work area of the RAM 25-2 as the compiled execution module 44 (S111). This process corresponds to the function of the file load unit 34 shown in FIG. 3.

Then, the CPU 22 directly executes the native code stored in the work area of the RAM 25-2 as the compiled execution module 44 (S112). This process corresponds to the function of the program execution unit 35 shown in FIG. 3.

After executing the compiled execution module 44, the CPU 22 determines whether or not the program source module 41 stored in the work area of the RAM 25-2 has been completely executed (S113). If the determination result is YES, then the current JIT compiling process terminates. If the determination result is NO, then control is returned to S102, and the above mentioned processes are repeated on the method definition described to be executed next in order in the program source module 41.

The above mentioned processes are shown as the JIT compiling process in FIG. 5.

Described below is the second example of the program executing device embodying the present invention.

In the second example, the hard disk device 26 stores in advance the native code obtained by compiling the method definition which can be described in the program source module 41. Thus, even when the program source module 41 is first executed in the program execution device 10, the native code obtained by compiling the method definition described in the program source module 41 can be obtained from the hard disk device 26. Therefore, the time lag caused in the method compiling process when the execution is started can be shortened.

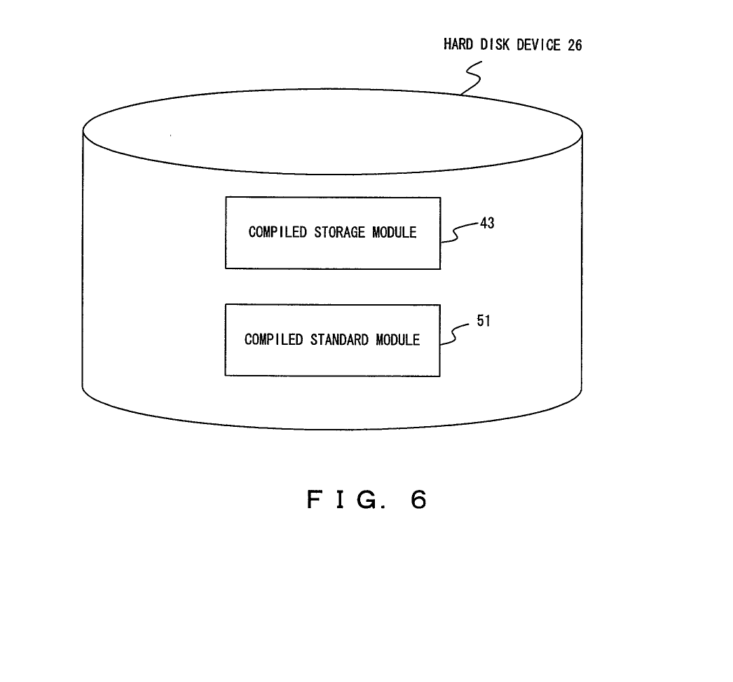

The entire configuration of the second example of the program execution device embodying the present invention is the same as that shown in FIG. 2, but in the components shown in FIG. 2, the data stored in the hard disk device 26 are different from those of the first example. FIG. 6 shows the data stored in the hard disk device in the second example of the program execution device. The hard disk device 26 stores the compiled storage module 43 as in the first example, and also stores in advance a compiled standard module 51 obtained by compiling the method definition which can be described in the program source module 41. As the method definition which is compiled into a native code and stored in the hard disk device 26 as the compiled standard module 51, the method definition which is certified in an optional Java execution system, such as the method definition which belongs to the class contained in the java package which is a Java standard class library, can be applicable.

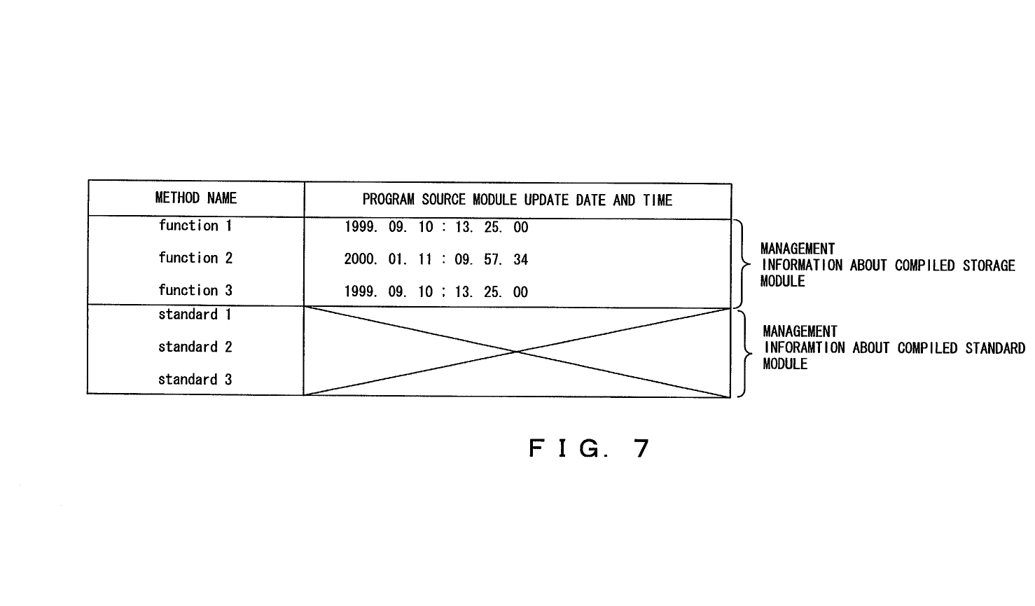

Described below is the table shown in FIG. 7. FIG. 7 is a table showing an example of the management note 42 in the second example of the program execution device embodying the present invention. The data stored in the hard disk device 26 corresponds to the contents shown in FIG. 6. In FIG. 7, as compared with FIG. 4 showing the data stored in the management note 42 according to the first embodiment of the present invention, the management information about the compiled storage module 43 is stored in the management note 42, and the management information about the compiled standard module 51 is stored in advance in the management note 42. As the management information about the compiled standard module 51, the method name of the method definition which is compiled into the compiled standard module 51 is stored in the management note 42.

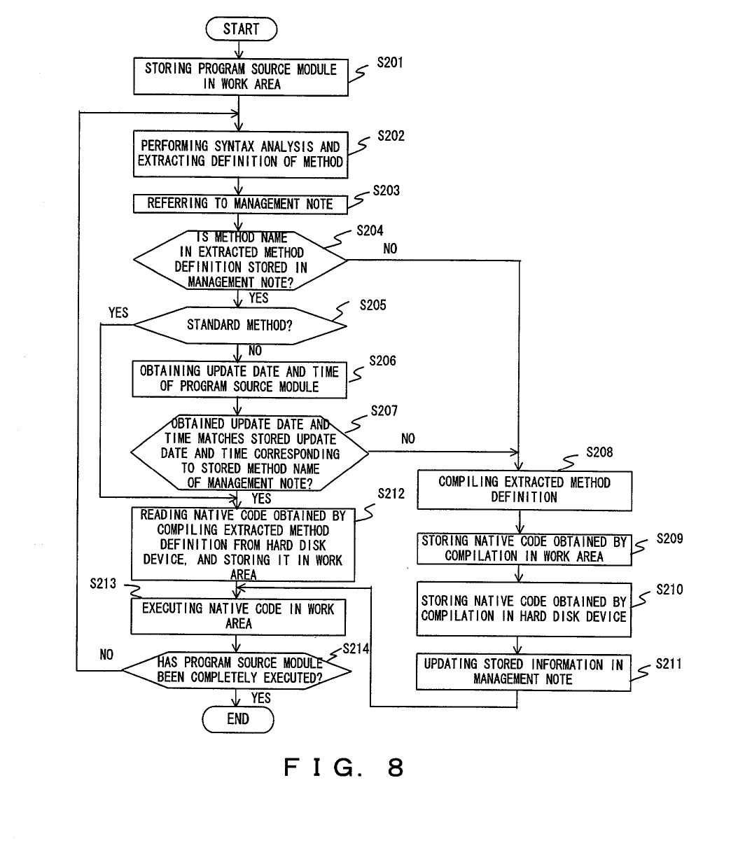

The contents of the JIT compiling process performed by the CPU 22 in the second example of the program execution device embodying the present invention are described below by referring to the flowchart shown in FIG. 8.

First, the processes performed in S201 through S204 shown in FIG. 8 are the same as those performed in S101 through S104 in the JIT compiling process shown in the flowchart in FIG. 5, and the detailed explanation is omitted here.

In S205, the CPU 22 determines whether or not the method name of the method definition extracted in S202 is stored as the management information about the compiled standard module 51 of the management note 42. If the result of the determining process is YES, then control is passed to S212. If it is NO, then control is passed to S206.

The processes in S206 through S214 after the process in S205 shown in FIG. 8 are the same as those in S105 through S113 in the first example of the JIT compiling process shown in flowchart in 5.

Described below is the third example of the program execution device embodying the present invention.

In the third example, when the power is applied to the program execution device, and the device starts its operation, the data stored in the hard disk device 26 is copied and stored in the RAM 25-2. In the JIT compiling process performed by the CPU 22, the compiling and executing process is performed not based on the data stored in the hard disk device 26, but based on the data copied from the data stored in the hard disk device 26 and stored in the RAM 25-2. Normally, the stored data can be read at a higher speed from semiconductor memory than from a hard disk device. Therefore, it is read from the semiconductor memory to shorten the time taken for compiling and executing the program source module 41 performed by the program execution device 10.

The entire configuration of the third example of the program execution device embodying the present invention is the same as that shown as the first example shown in FIG. 2, but an area of a cache area 62 storing the data copied from the data stored in the hard disk device 26 is provided in the storage area of the RAM 25-2 in addition to the area of a work area 61 temporarily used by the CPU 22 performing a process. The area of the cache area 62 maintains the data stored therein without clearing it even after the CPU 22 has completed the JIT compiling process described later so that the stored data can be used in the JIT compiling process if it is re-executed later.

The data stored in the management note 42 can be the same as that shown in FIG. 4. Although the management note 42 is stored in the hard disk device 26 in the above mentioned first example, the data stored in the management note 42 of the hard disk device 26 is copied to the RAM 25-2 in the third example, and the CPU 22 performs the process by referring to the management note 42 in the RAM 25-2.

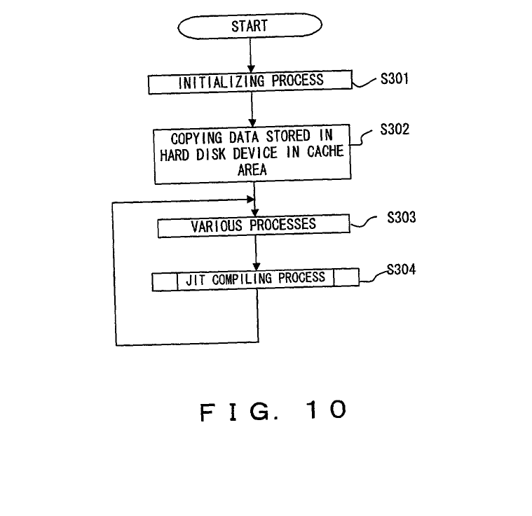

FIG. 10 is a flowchart showing the contents of the process of controlling the entire device in the third example of the program execution device embodying the present invention. This process is performed by the CPU 22 immediately after the power is applied to the present device 20.

When the power is applied to the present device, the CPU 22 first performs the initializing process (S301). The initializing process is performed by the CPU 22 by initializing various registers of the CPU 22, the RAM 25-2, etc.

Then, the CPU 22 copies the data stored in the hard disk device 26 to the cache area 62 of the RAM 25-2 (S302).

Then, the CPU 22 performs various processes of controlling the input unit 21, the output unit 23, the I/F unit 24, etc. of the present device 20 (S303), and then performs the JIT compiling process (S304). After completing the process, control is returned to S303, and the subsequent processes are repeated.

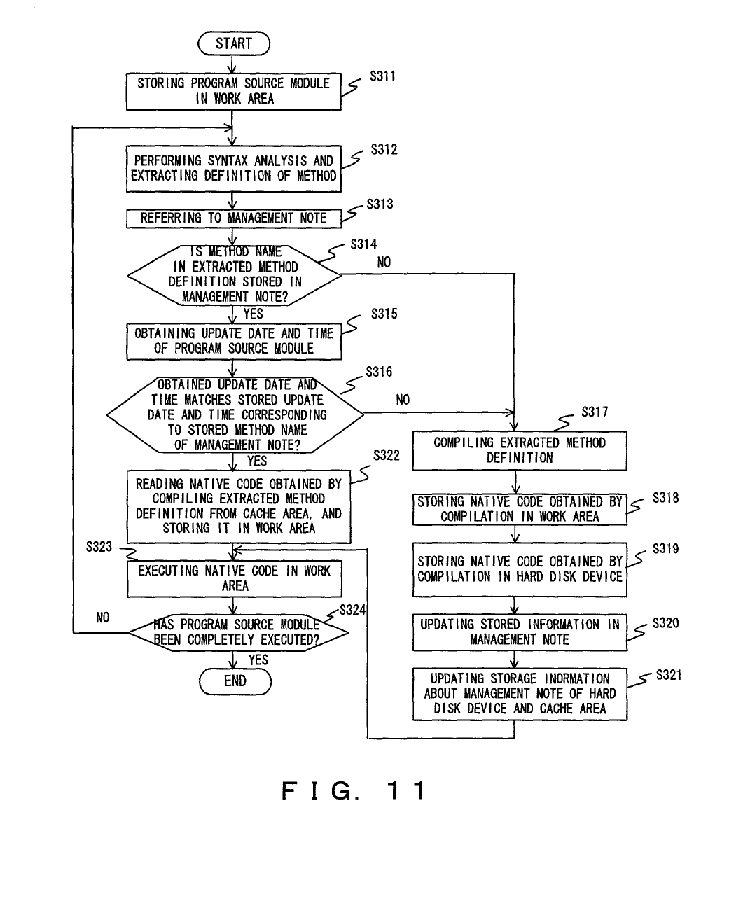

Described below are the processes shown in FIG. 11. FIG. 11 is a flowchart of the contents of the JIT compiling process shown as S304 in FIG. 10.

First, the processes shown in S311 through S319 in FIG. 11 are the same as those in S101 through S109 in the first example of the JIT compiling process shown in the flowchart in FIG. 5. However, in S313, the CPU 22 refers to the management note 42 stored in the cache area 62 and copied from the hard disk device 26.

In S320, the native code obtained by the compiling process in S317 is also stored the cache area 62 of the RAM 25-2, and the native code is set to match the data stored in the hard disk device 26 in S319 and the data stored in the cache area 62.

Then, the CPU 22 updates the management notes 42 of the hard disk device 26 and the cache area 62, and the method name of the method definition compiled in S317 is stored corresponding to the update date and time indicated by the management information of the program file storing the program source module 41 describing the method definition (S321). Then, control is passed to S323.

If the result of the determining process in S316 is YES, the CPU 22 reads the native code obtained by compiling the method definition extracted in the process in S312 from the cache area 62, and stores the read native code in the work area of the RAM 25-2 as the compiled execution module 44 (S322).

The processes in S323 and S324 after the process in S322 shown in FIG. 11 are the same as the processes in S112 and S113 in the first example of the JIT compiling process shown in the flowchart in FIG. 5, and the detailed explanation is omitted here.

In the second example, in which the hard disk device 26 in the program execution device stores in advance the native code obtained by compiling the method definition which can be described in the program source module 41, the data stored in the hard disk device 26 can be copied to the RAM 25-2 to perform the JIT compiling process as in the third example.

A general-purpose computer can perform the JIT compiling process described in each of the above mentioned embodiments according to the present invention. To attain this, the control program used to direct a computer to perform the process corresponding to the JIT compiling process shown in FIG. 5, 8, or 11 described in each of the embodiments of the present invention is stored in advance in a computer-readable storage medium, the control program read from the storage medium is temporarily stored in the main memory of the computer, and the program stored in the central processing unit of the computer is read and executed.

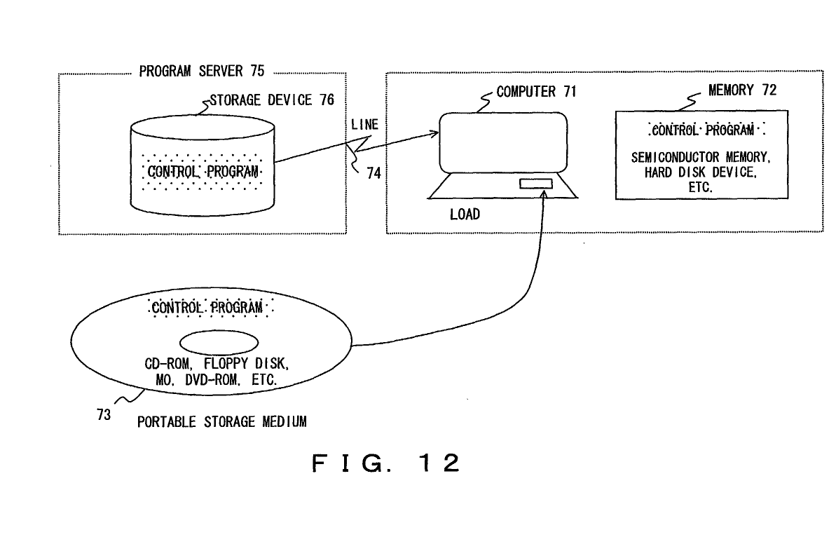

FIG. 12 shows an example of a computer-readable storage medium storing the above mentioned control program. Such a storage medium can be, for example, memory 72 such as semiconductor memory, a hard disk, etc. built in or external to a computer 71, a portable storage medium 73 such as CD-ROM, DVD-ROM, MO (magneto-optical disk), a floppy disk, etc.

The storage medium can also be a storage device 76 of a program server 75 which is a computer connected to the computer 71 through a line 74. In this case, a transmission signal obtained by modulating a carrier wave by a data signal expressing a control program is transmitted from the program server 75 through the line 74 which is a transmission medium. The computer 71 reproduces the control program by demodulating the received transmission signal, thereby executing the control program.

As described above in detail, the present invention is based on an apparatus for compiling a source program into a machine language directly executable on a platform of a specific processing system, and executing the machine language using a just-in-time-compiler system. In the apparatus, the machine language obtained by compiling the source program is stored in a storage unit for maintain the stored data for each function expressed in the source program although the supply voltage has dropped. Then, it is determined whether or not the machine language obtained by compiling the function described in the source program is stored in the storage unit. Based on the determination result, either the machine language obtained by compiling the source program or the machine language stored in the storage unit is directly executed on the platform of a specific processing system. With the configuration, when the same source program is re-executed after turning off the power supply, a source program can be executed without a time lag caused by a program compiling process when the execution is started.

Otherwise, the present invention is based on an apparatus for compiling a source program into a machine language directly executable on a platform of a specific processing system, and executing the machine language using a just-in-time-compiler system. In the apparatus, the machine language obtained by compiling the source program is stored for each function expressed in the source program corresponding to the date and time of the update of the source program before compiling into the machine language. Then, it is determined whether or not the date and time of the update of the source program matches the update date and time corresponding to the stored machine language. Based on the determination result, either the machine language obtained by compiling the source program or the machine language stored in the storage unit is directly executed on the platform of a specific processing system. With the configuration, although a source program is amended, the source program can be correctly executed based on the amendment without a time lag caused by a program compiling process.

As described above, the performance at the start of the execution of the source program using the JIT compiler can be enhanced with any of the above mentioned configurations.

What is claimed is:

1. An apparatus having an execution unit for executing a machine language, compiling a source program into a machine language directly executable by the execution unit, and executing the machine language in a just-in-time-compiler system, comprising:
a storage unit storing for each function a machine language executable by the execution unit obtained by compiling a function described in the source program, and maintaining stored data although a power supply voltage has dropped;
a compiling unit compiling the source program into a machine language executable by the execution unit;
a storage control unit storing the machine language compiled by said compiling unit;
a determination unit determining whether or not a machine language obtained by compiling a function used in the source program is stored in said storage unit; and
an execution control unit instructing the execution unit to directly execute either a machine language compiled by said compiling unit or a machine language stored in said storage unit depending on a determination result obtained by said determination unit.

2. The apparatus according to claim 1, wherein said storage unit stores in advance a machine language obtained by compiling a function which can be used in the source program.

3. The apparatus according to claim 1, further comprising
semiconductor memory copying and storing data stored in said storage unit, wherein
said execution control unit instructs the execution unit to execute a machine language copied from the data stored in said storage unit and stored in said semiconductor memory instead of instructing the execution unit to execute a machine language stored in said storage unit.

4. The apparatus according to claim 1, wherein
said source program is described in Java byte code.

5. An apparatus having an execution unit for executing a machine language, compiling a source program into a machine language directly executable by the execution unit, and executing the machine language in a just-in-time-compiler system, comprising:
a storage unit storing for each function a machine language executable by the execution unit obtained by compiling a function described in the source program, and maintaining stored data after the source program has been executed;
a compiling unit compiling the source program into a machine language executable by the execution unit;
a storage control unit storing the machine language compiled by said compiling unit corresponding to update date and time of the source program compiled by said compiling unit;
a determination unit determining whether or not the update date and time of the source program matches an update date and time corresponding to the machine language stored in said storage unit; and
an execution control unit instructing the execution unit to directly execute either a machine language compiled by said compiling unit or a machine language stored in said storage unit depending on a determination result obtained by said determination unit.

6. The apparatus according to claim 5, further comprising
a read unit reading a program file storing the source program, wherein
said storage control unit stores the machine language in said storage unit by assuming that the update date and time of the program file indicated in the program file is the update date and time of the source program corresponding to the machine language; and
said determination unit determines whether or not the update date and time of the program file indicated in the program file matches the update date and time stored in said storage unit corresponding the machine language.

7. The apparatus according to claim 5, wherein said source program is described in Java byte code.

8. An apparatus having execution means for executing a machine language, compiling a source program into a machine language directly executable by said execution means, and executing the machine language in a just-in-time-compiler system, comprising:
storage means for storing for each function a machine language executable by the execution means obtained by compiling a function described in the source program, and maintaining stored data although a power supply voltage has dropped;
compiling means for compiling the source program into a machine language executable by the execution means;
storage control means for storing the machine language compiled by said compiling means;
determination means for determining whether or not a machine language obtained by compiling a function used in the source program is stored in said storage means; and
execution control means for instructing the execution means to directly execute either a machine language compiled by said compiling means or a machine language stored in said storage means depending on a determination result obtained by said determination means.

9. An apparatus having execution means for executing a machine language, compiling a source program into a machine language directly executable by the execution means, and executing the machine language in a just-in-time-compiler system, comprising:
storage means for storing for each function a machine language executable by the execution means obtained by compiling a function described in the source program, and maintaining stored data after the source program has been executed;
compiling means for compiling the source program into a machine language executable by the execution means;
storage control means for storing the machine language compiled by said compiling means corresponding to update date and time of the source program compiled by said compiling means;
determination means for determining whether or not the update date and time of the source program matches an update date and time corresponding to the machine language stored in said storage means; and
execution control means instructing the execution means to directly execute either a machine language compiled by said compiling means or a machine language stored in said storage means depending on a determination result obtained by said determination means.

10. A method for executing a program based on a just-in-time-compiler system for compiling a source program into a machine language directly executable on a platform of a specific processing system, and executing the machine language, comprising:
storing in a storage unit, which maintains stored data although a supply voltage has dropped, the machine language obtained by compiling the source program for each function expressed in the source program;
determining whether or not the machine language obtained by compiling the function described in the source program is stored in the storage unit; and
setting either the machine language obtained by compiling the source program or the machine language stored in the storage unit to be directly executed on a platform of a specific processing system based on a determination result.

11. A method for executing a program based on a just-in-time-compiler system for compiling a source program into a machine language directly executable on a platform of a specific processing system, and executing the machine language, comprising:
storing the machine language obtained by compiling the source program for each function described in the source program corresponding to an update date and time of the source program before compiled into a machine language;
determining whether or not the date and time of the update of the source program matches an update date and time corresponding to the stored machine language; and
setting either the machine language obtained by compiling the source program or the machine language stored in the storage unit to be directly executed on a platform of a specific processing system based on a determination result.

12. A computer-readable storage medium storing a computer program used to direct a computer based on a just-in-time-compiler system to compile a source program into a machine language directly executable on a platform of a specific processing system, and execute the machine language, comprising:
storing in a storage unit, which maintains stored data although a supply voltage has dropped, the machine language obtained by compiling the source program for each function expressed in the source program;
determining whether or not the machine language obtained by compiling the function described in the source program is stored in the storage unit; and
setting either the machine language obtained by compiling the source program or the machine language stored in the storage unit to be directly executed on a platform of a specific processing system based on a determination result.

13. A computer-readable storage medium storing a computer program used to direct a computer based on a just-in-time-compiler system to compile a source program into a machine language directly executable on a platform of a specific processing system, and execute the machine language, comprising:
storing the machine language obtained by compiling the source program for each function described in the source program corresponding to an update date and time of the source program before compiled into a machine language;
determining whether or not the date and time of the update of the source program matches an update date and time corresponding to the stored machine language; and
setting either the machine language obtained by compiling the source program or the machine language stored in the storage unit to be directly executed on a platform of a specific processing system based on a determination result.

14. A computer program embodied on a transmission medium used to direct a computer based on a justin-time-compiler system to compile a source program into a machine language directly executable on a platform of a specific processing system, and execute the machine language, comprising:
storing in a storage unit, which maintains stored data although a supply voltage has dropped, the machine language obtained by compiling the source program for each function expressed in the source program;
determining whether or not the machine language obtained by compiling the function described in the source program is stored in the storage unit; and
setting either the machine language obtained by compiling the source program or the machine language stored in the storage unit to be directly executed on a platform of a specific processing system based on a determination result.

15. A computer program embodied on a transmission medium used to direct a computer based on a just-in-time-compiler system to compile a source program into a machine language directly executable on a platform of a specific processing system, and execute the machine language, comprising:
storing the machine language obtained by compiling the source program for each function described in the source program corresponding to an update date and time of the source program before compiled into a machine language;
determining whether or not the date and time of the update of the source program matches an update date and time corresponding to the stored machine language; and
setting either the machine language obtained by compiling the source program or the machine language stored in the storage unit to be directly executed on a platform of a specific processing system based on a determination result.

16. A computer data signal embodied in a carrier wave containing a computer program used to direct a computer based on a just-in-time-compiler system to compile a source program into a machine language directly executable on a platform of a specific processing system, and execute the machine language, said computer program comprising:
storing in a storage unit, which maintains stored data although a supply voltage has dropped, the machine language obtained by compiling the source program for each function expressed in the source program;
determining whether or not the machine language obtained by compiling the function described in the source program is stored in the storage unit; and
setting either the machine language obtained by compiling the source program or the machine language stored in the storage unit to be directly executed on a platform of a specific processing system based on a determination result.

17. A computer data signal embodied in a carrier wave containing a computer program used to direct a computer based on a just-in-time-compiler system to compile a source program into a machine language directly executable on a platform of a specific processing system, and execute the machine language, said computer program comprising:
storing the machine language obtained by compiling the source program for each function described in the source program corresponding to an update date and time of the source program before compiled into a machine language;
determining whether or not the date and time of the update of the source program matches an update date and time corresponding to the stored machine language; and
setting either the machine language obtained by compiling the source program or the machine language stored in the storage unit to be directly executed on a platform of a specific processing system based on a determination result.
